(19) United States
(12) Patent Application Publication
(10) Pub. No.: US 2018/0170069 A1
(43) Pub. Date: Jun. 21, 2018

(54) RECORDING MEDIUM, LABEL IMAGE PREPARING METHOD, AND LABEL IMAGE PREPARING APPARATUS

(71) Applicant: CASIO COMPUTER CO., LTD., Tokyo (JP)

(72) Inventors: Keisuke SHIMA, Tokyo (JP); Kiyoshi OGAWA, Tokyo (JP)

(73) Assignee: CASIO COMPUTER CO., LTD., Tokyo (JP)

(21) Appl. No.: 15/796,341

(22) Filed: Oct. 27, 2017

(30) Foreign Application Priority Data
Dec. 21, 2016 (JP) 2016-248093

(51) Int. Cl. B41J 3/407; B41J 3/46; G06K 15/02; G06F 3/12

(52) U.S. Cl. CPC B41J 3/4075; B41J 3/46; B41J 11/703; G06F 3/1256; G06K 15/024

(57) ABSTRACT

A recording medium has recorded a program causing a computer of a label image preparing apparatus to perform: a function of causing a display to display a preparation screen in which a plurality of label images are arranged such that a length of a first side in a first direction of one label image of the plurality of label images corresponds to a length in a width direction of a printing medium, lengths of second sides in a second direction crossing the first direction of the plurality of label images coincide with each other, and positions of the first sides in the first direction are aligned; a function of arranging at least one part image as a printing object in the plurality of label images in the preparation screen; and a function of detecting that the at least one part image is arranged over at least two label images of the plurality of label images.

### RELATED APPLICATIONS

The entire contents of JP Patent Application No. 2016-248093, filed on Dec. 21, 2016 are incorporated in the present specification by reference.

### BACKGROUND

The present disclosure relates to a recording medium, a label image preparing method, and a label image preparing apparatus.

### DESCRIPTION OF THE RELATED ART

In the related art, a label printer that prepares a label by cutting a long printing medium after printing a label image including parts such as characters, pictures, or figures to be printed on the long printing medium is known (for example, see JP 2011-197228 A).

### BRIEF SUMMARY

An object of the disclosure is to provide a recording medium, a label image preparing method, and a label image preparing apparatus that performs process of determining that a plurality of labels are arranged in a width direction crossing a length direction and are adhered to an adhesion object.

According to an embodiment of the present disclosure, a recording medium has recorded a program causing a computer of a label image preparing apparatus to perform: a function of causing a display to display a preparation screen in which a plurality of label images are arranged such that a length of a first side in a first direction of one label image of the plurality of label images corresponds to a length in a width direction of a printing medium, lengths of second sides in a second direction crossing the first direction of the plurality of label images coincide with each other, and positions of the first sides in the first direction are aligned; a function of arranging at least one part image as a printing object in the plurality of label images in the preparation screen; and a function of detecting that the at least one of part image is arranged over at least two label images of the plurality of label images.

According to an embodiment of the present disclosure, a label image preparing method comprises: causing a display to display a preparation screen in which a plurality of label images are arranged such that a length of a first side in a first direction of one label image of the plurality of label images corresponds to a length in a width direction of a printing medium, lengths of second sides in a second direction crossing the first direction of the plurality of label images coincide with each other, and positions of the first sides in the first direction are aligned; arranging at least one part image as a printing object in the plurality of label images in the preparation screen; and detecting that the at least one part image is arranged over at least two label images of the plurality of label images.

According to an embodiment of the present disclosure, a label image preparing apparatus comprises a display and a processor. The processor is configured to: cause a display to display a preparation screen in which a plurality of label images are arranged such that a length of a first side in a first direction of one label image of the plurality of label images corresponds to a length in a width direction of a printing medium, lengths of second sides in a second direction crossing the first direction of the plurality of label images coincide with each other, and positions of the first sides in the first direction are aligned; arrange at least one part image as a printing object in the plurality of label images in the preparation screen; and detect that the at least one part image is arranged over at least two label images of the plurality of label images.

### BRIEF DESCRIPTION OF THE SEVERAL VIEWS OF THE DRAWING

FIG. 1 is a diagram illustrating a label image preparing apparatus according to an embodiment;

FIG. 2 is a perspective view illustrating a printing apparatus according to the embodiment;

FIG. 3 is a control block diagram of the printing apparatus according to the embodiment;

FIG. 4 is a diagram illustrating an example of a label image preparing screen according to the embodiment;

FIG. 5 is a diagram illustrating an example of an editing number setting screen of a label image according to the embodiment;

FIG. 6 is a diagram illustrating an example of an image display area according to the embodiment;

FIG. 7 is a flowchart illustrating an arrangement of a frame according to the embodiment;

FIG. 8 is a (first) diagram illustrating an arrangement of a frame according to the embodiment;

FIG. 9 is a (second) diagram illustrating the arrangement of a frame according to the embodiment;

FIG. 10 is a (third) diagram illustrating the arrangement of a frame according to the embodiment;

FIG. 11 is a (first) diagram illustrating a first example of a frame according to the embodiment;

FIG. 12 is a (second) diagram illustrating the first example of a frame according to the embodiment;

FIG. 13 is a (third) diagram illustrating the first example of a frame according to the embodiment;

FIG. 14 is a (first) diagram illustrating a second example of a frame according to the embodiment;

FIG. 15 is a (second) diagram illustrating the second example of a frame according to the embodiment;

FIG. 16 is a (third) diagram illustrating the second example of a frame according to the embodiment;

FIG. 17 is a (fourth) diagram illustrating the second example of a frame according to the embodiment;

FIG. 18 is a flowchart illustrating extension of a label image according to the embodiment; and

FIG. 19 is a diagram illustrating extension of a label image according to the embodiment.

### DETAILED DESCRIPTION

Hereinafter, a program, a label image preparing method, and a label image preparing apparatus according to an embodiment of the disclosure will be described with reference to the accompanying drawings.

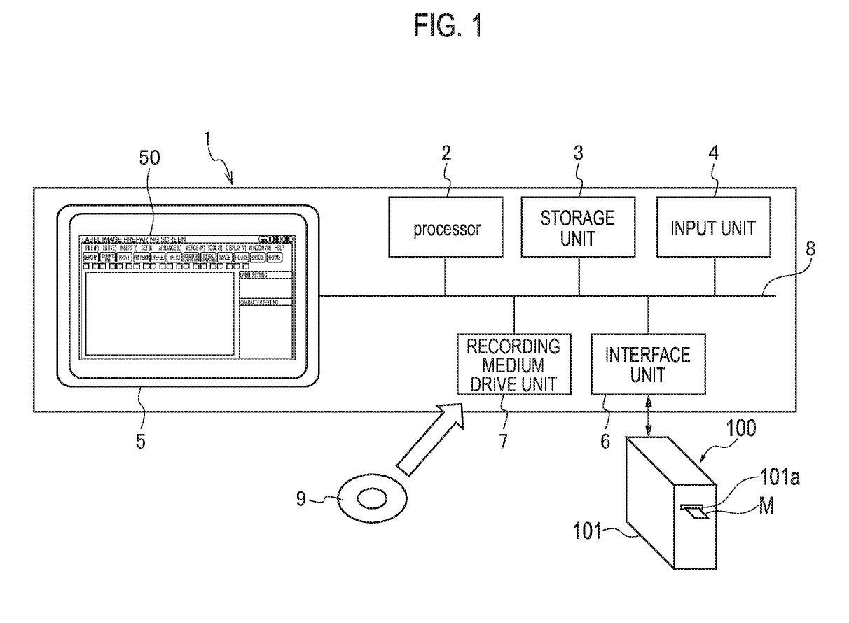

FIG. 1 is a diagram illustrating a label image preparing apparatus 1 according to the embodiment.

The label image preparing apparatus 1 includes a processor 2 which is an example of a processor, a storage unit 3, an input unit 4, a display 5, an interface unit 6, and a recording medium drive unit 7. These elements are connected to each other via a bus line 8 and transmit and receive a variety of data to and from each other. The label image preparing apparatus 1 can be a computer including the processor 2 and the display 5, and examples thereof include portable terminals such as a smartphone and a tablet in addition to a personal computer. When a processor 103 of a printing apparatus 100 illustrated in FIG. 3 performs the same processing as the processor 2 which will be described later and the printing apparatus 100 includes a display, the printing apparatus 100 functions as the label image preparing apparatus 1.

The processor 2 is an arithmetic processing unit that controls the whole operation of the label image preparing apparatus 1. The processor 2 reads and executes a control program such as a label image preparing program.

The storage unit 3 includes a read only memory (ROM), a random access memory (RAM), and a hard disk.

The ROM is a read-only semiconductor memory in which a predetermined basic control program is recorded in advance. A memory in which stored data is non-volatile at the stop time of supply of power, such as a flash memory, may be used as the ROM.

The RAM is a randomly accessible semiconductor memory which is used as a work memory area if necessary when the processor 2 executes a variety of control programs.

The hard disk stores a variety of control programs which are executed by the processor 2 or a variety of data.

The input unit 4 is, for example, a keyboard unit or a mouse unit. When the input unit is operated by a user of the label image preparing apparatus 1, a variety of input information from the user correlated with operation details is acquired and the acquired input information is sent to the processor 2.

The display 5 is, for example, a display and displays a label image preparing screen 50 which is a preparation screen for preparing a label image. When the display 5 is a touch panel, the display 5 also functions as the input unit 4.

The interface unit 6 manages transmitting and receiving of a variety of information to and from various devices. For example, the interface unit 6 transmits a label image (printing data) including at least a part of parts which are a printing object including characters, pictures, or figures to the printing apparatus 100 which are connected in a wired or wireless manner. A system including the label image preparing apparatus 1 and the printing apparatus 100 can be referred to as a printing system.

The recording medium drive unit 7 is a device that reads various control programs or data recorded on a portable recording medium 9. The processor 2 can perform processes of preparing a label image by reading and executing a predetermined program recorded on the portable recording medium 9 via the recording medium drive unit 7. Examples of the portable recording medium 9 include a compact disc read only memory (CD-ROM), a digital versatile disc read only memory (DVD-ROM), and a flash memory including a USB standard connector.

In order to cause a computer including the processor 2 to function as the label image preparing apparatus 1, first, a control program which causes the processor 2 to perform various processes is prepared. The prepared control program is stored in the hard disk of the storage unit 3 or the portable recording medium 9 in advance. By inputting a predetermined instruction to the processor 2, the control program is read and executed. Accordingly, the computer including the processor 2 operates as the label image preparing apparatus 1. The program in this embodiment is a program (for example, a program for preparing a label image) causing the computer to print a long printing medium M on the basis of a plurality of label images on which printing objects (parts) are arranged.

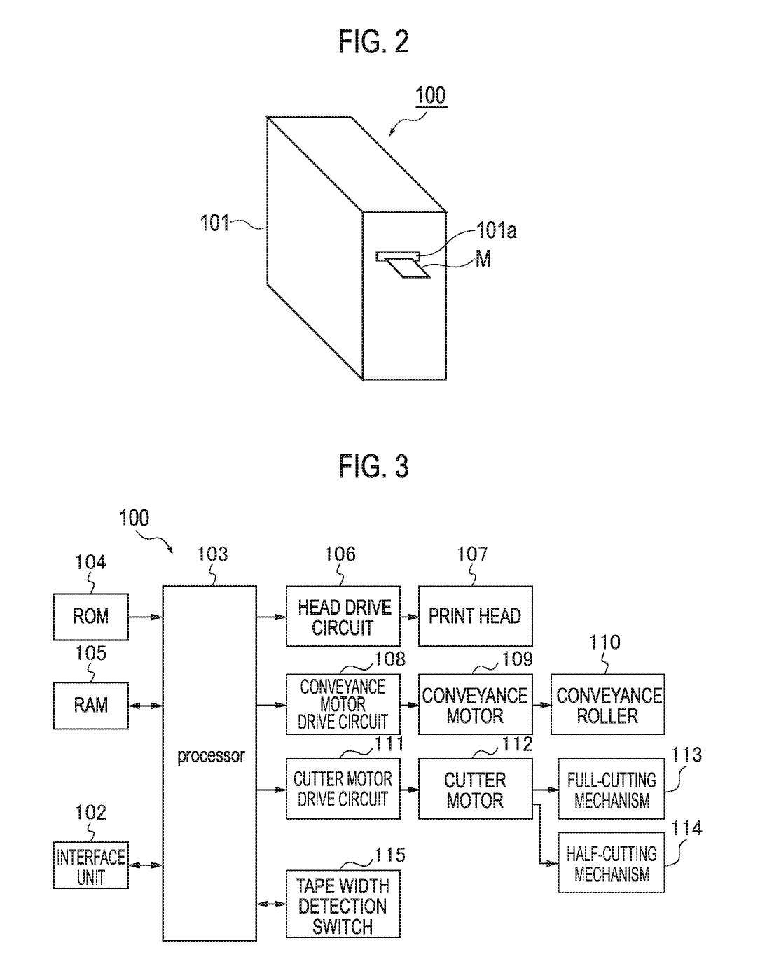

FIG. 2 is a perspective view illustrating the printing apparatus 100 according to this embodiment.

FIG. 3 is a control block diagram of the printing apparatus 100.

The printing apparatus 100 illustrated in FIGS. 2 and 3 prepares a label by printing a label image received from the label image preparing apparatus 1 illustrated in FIG. 1 on a long printing medium M and then cutting the long printing medium in a preset length.

In an apparatus housing 101 illustrated in FIG. 2, a discharge port 101a that discharges a printing medium M to the outside of the apparatus housing 101 is formed. A power supply cord connection terminal and an external device connection terminal and a storage medium insertion hole which serve as an interface unit 102 to be described later are disposed in the apparatus housing 101. For example, a lid which is not illustrated for attachment and detachment of a cassette accommodating a printing medium M is disposed in the apparatus housing 101.

As illustrated in FIG. 3, the printing apparatus 100 includes an interface unit 102, a processor 103, a ROM 104, a RAM 105, a head drive circuit 106, a print head 107 which is an example of a printing unit, a conveyance motor drive circuit 108, a conveyance motor 109, a conveyance roller 110, a cutter motor drive circuit 111, a cutter motor 112, a full-cutting mechanism 113, a half-cutting mechanism 114, and a tape width detection switch 115.

The interface unit 102 is connected to the interface unit 6 of the label image preparing apparatus 1 in a wired or wireless manner and receives a label image from the label image preparing apparatus 1.

The processor 103 starts a system program stored in advance in the ROM 104, a control program stored in a memory card, and a control program read from an external device and controls operations of circuit units using the RAM 105 as a work memory.

The head drive circuit 106 controls the print head 107 on the basis of the label images which has been received from the label image preparing apparatus 1 and stored in the RAM 105 by the interface unit 102. The print head 107 prints a desired label image on a printing medium M by thermal transfer using an ink ribbon along with a platen roller which is the conveyance roller 110 under the control.

The conveyance motor drive circuit 108 controls the conveyance roller 110 by controlling the conveyance motor 109 on the basis of the label images stored in the RAM 105, and conveys the printing medium M at a desired speed during printing on the printing medium M by the print head 107.

The cutter motor drive circuit 111 controls the operation of the cutter motor 112 activating the full-cutting mechanism 113 that cuts both of a substrate of the printing medium M and a sheet of exfoliative paper adhered to an adhesive surface of the substrate and the half-cutting mechanism 114 that cuts only the substrate of the printing medium M.

The tape width detection switch 115 is disposed in a cassette accommodating section in the apparatus housing 101, and automatically determines a type of a tape cassette, that is, a tape width of the printing medium M, by detecting a shape of an uneven portion formed in the tape cassette inserted into the cassette accommodating section.

The printing apparatus 100 is only an example, and the printing apparatus in this embodiment has only to be an apparatus that prepares a print matter by printing a label image on a printing medium M. For example, the print head 107 which is an example of a printing unit may be a printing unit that performs printing on a printing medium M using another printing method such as an ink jet method.

The printing apparatus 100 may include an input unit or a display. An example of the input unit is an input unit including one or all of an input key that is used to input parts such as a character, a picture, or a figure, a print key that instructs start of printing, a cursor key that is operated to move a cursor on a display screen of the display, and various control keys that are used to perform setting a print mode or various setting processes. An example of the display is a liquid crystal display panel and is a display that displays a character, a picture, a figure, or the like corresponding to an input from the input unit, a selection menu for various settings, a screen for alarming a user at the time of error, and a message associated with various processes.

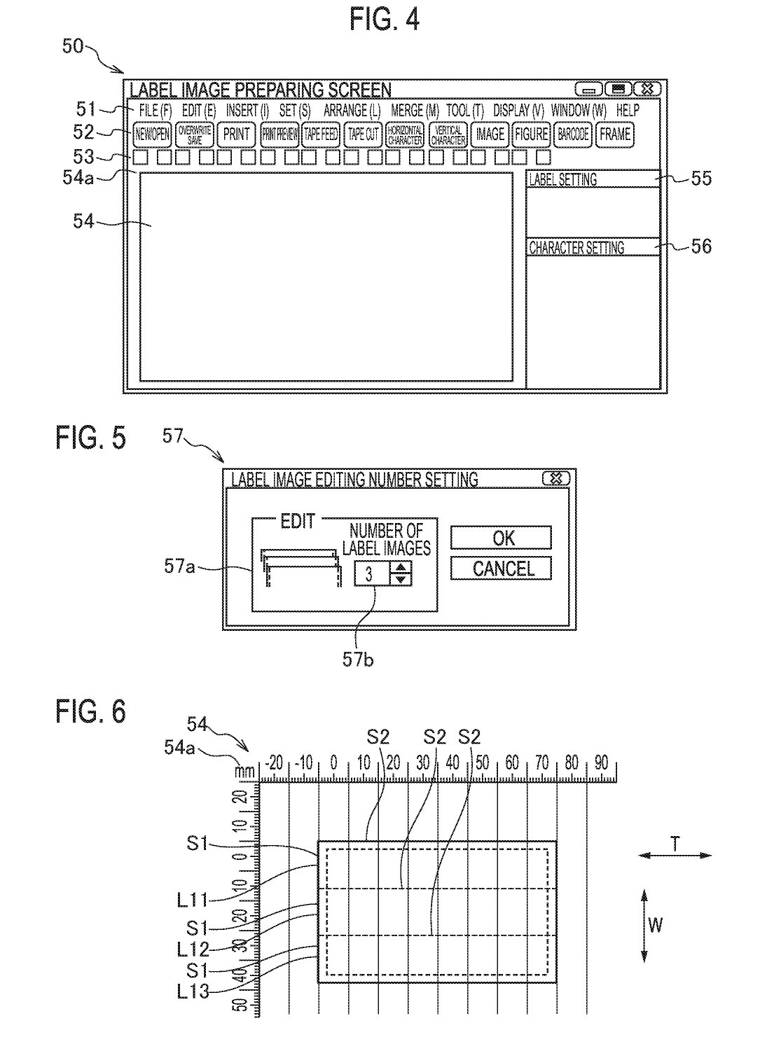

FIG. 4 is a diagram illustrating an example of a label image preparing screen 50 according to this embodiment.

The label image preparing screen 50 illustrated in FIG. 4 is an example of an image which is displayed on the display 5 of the label image preparing apparatus 1 illustrated in FIG. 1.

The label image preparing screen 50 includes a menu bar 51, a large tool bar 52, a small tool bar 53, an image display area 54, a label setting section 55, and a character setting section 56.

The menu bar 51 displays a function list associated with each menu when the menu such as file or edit is pressed.

Large buttons and small buttons are arranged in the large tool bar 52 and the small tool bar 53, respectively, and the processor 2 performs a process corresponding to the operation when each button (icon) is pressed.

A scale 54a indicating positional coordinates is displayed in the unit of mm in an upper end and a left end of the image display area 54 as illustrated in FIG. 6. The horizontal axis of the scale 54a represents a length in a second direction T of label images L11, L12, and L13 which is a conveyance direction (a length direction) of the printing medium M illustrated in FIG. 2, and the vertical axis of the scale 54a represents a width of the label images L11, L12, and L13 in a first direction (corresponding to a width direction of the printing medium M) W crossing the second direction T (which includes a case in which it is perpendicular thereto). Here, a length of a first side S1 in the first direction W of one label image of a plurality of label images L11, L12, and L13 corresponds to a length in the width direction of the printing medium M. Lengths of second sides S2 in the second direction T of the plurality of label images L11, L12, and L13 coincide with each other. A plurality of label images L11, L12, and L13 are arranged such that the positions of the first sides S1 are aligned in the first direction W. The label images L11, L12, and L13 are displayed to be arranged in the first direction W, and a state before parts to be printed are disposed in the label images L11, L12, and L13 is illustrated in FIG. 6, but the parts is individually printed on a plurality of labels having substantially the same size. In FIG. 6, reference signs of the first sides S1 are added to the left sides of the label images L11, L12, and L13 and reference signs of the second sides S2 are added to the upper sides thereof, but the right sides can be denoted by the first sides S1 and the lower sides can be denoted by the second sides S2. In the printing apparatus 100, details of the label images L11, L12, and L13 are printed, for example, rightward from the left side to the right side.

Regarding the number of label images L11, L12, and L13, for example, as illustrated in FIG. 5, the number of label images edited is set by a user in a label image editing number setting screen 57. Accordingly, the processor 2 receives setting of the number of label images to be edited and displays the set number of label images L11, L12, and L13 in the label image preparing screen 50 (the image display area 54).

In the label setting section 55 illustrated in FIG. 4, widths, lengths, and the like of the label images L11, L12, and L13 (labels) are set.

In the character setting section 56, font, size, direction, and the like of characters included in one or more parts (see parts P10 illustrated in FIG. 8 which will be described later) constituting the label images L11, L12, and L13 are set.

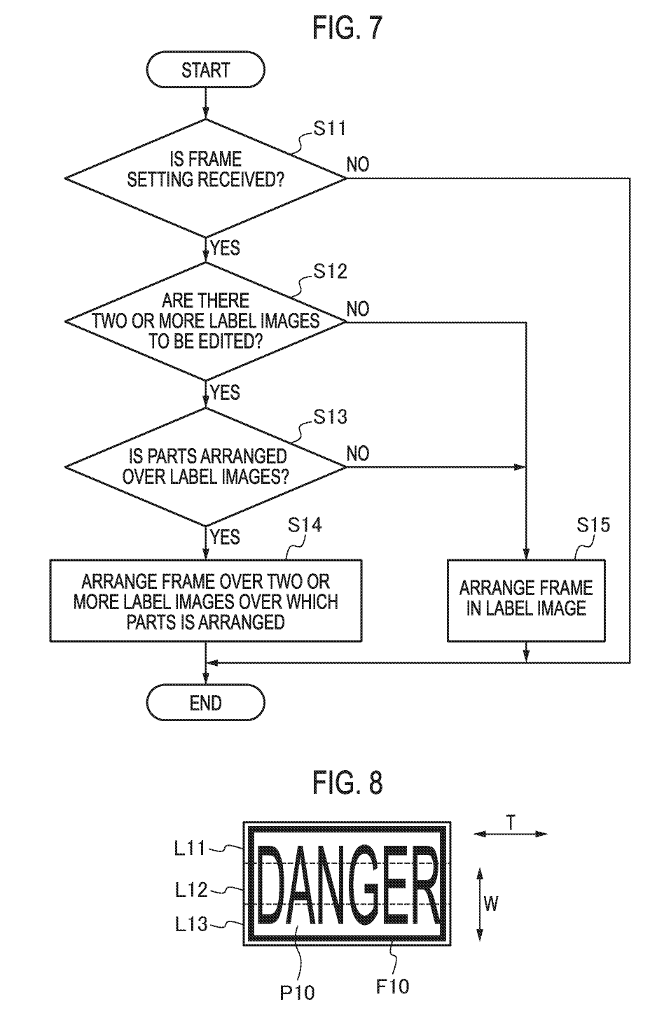

FIG. 7 is a flowchart illustrating an arrangement of a frame according to the embodiment.

The routine of the flowchart illustrated in FIG. 7 is performed after the processor 2 displays the label image preparing screen 50 on the display 5 illustrated in FIG. 1, or after a plurality of parts to be printed are further arranged in a plurality of label images L11, L12, and L13 in the label image preparing screen 50 of the display 5 on the basis of a user's operation. The user's operation is performed, for example, using a keyboard unit or a mouse unit of the input unit 4 illustrated in FIG. 1 as described above.

First, when the button “frame” of the large tool bar 52 illustrated in FIG. 4 is a pressed by a user, the processor 2 continuously determines whether setting of arranging a frame F10 illustrated in FIG. 8 has been received, for example, until setting is received (step S11). The frame F10 is arranged in a periphery in the label images L11, L12, and L13 and has a rectangular frame shape in FIG. 8, but may be, for example, a rectangular frame shape of which corners are rounded or a frame shape including a decoration portion such as a picture or a figure.

When setting of arranging the frame F10 is not received (NO in step S11), the processor 2 ends the routine of the flowchart illustrated in FIG. 7. A case in which setting is not received is, for example, a case in which an operation of editing completion of the label images L11, L12, and L13 or an operation of transmitting the label images L11, L12, and L13 to the printing apparatus 100 is received before the setting of arranging the frame F10 is received.

When the setting of arranging the frame F10 is received (YES in step S11), the processor 2 determines whether the number of label images L11, L12, and L13 to be edited is two or more (step S12). The number of label images L11, L12, and L13 to be edited is the number of label images set by a user in the label image editing number setting screen 57 illustrated in FIG. 5 as described above, that is, the number of label images L11, L12, and L13 displayed in the image display area 54 illustrated in FIG. 6. Alternatively, when the number of label images to be edited increases on the basis of an operation of copying the label images during the user's editing operation after the number of label images to be edited has been set, the number of label images to be edited is the increasing number of label images to be edited.

When it is determined that the number of label images L11, L12, and L13 to be edited is two or more (YES in step S12), the processor 2 determines whether the parts P10 illustrated in FIG. 8 is arranged over a plurality of label images L11, L12, and L13 (step S13). Detection of whether the parts P10 is arranged over at least two label images L11, L12, and L13 can be performed, for example, by comparing information of the positional coordinates of the label images L11, L12, and L13 with information of the positional coordinates of the parts P10.

The parts P10 illustrated in FIG. 8 is a parts including text of “danger,” but the parts is not limited to a parts including text, and may be a parts including a picture, a parts including a figure, or a parts including a combination of text, a picture, and a figure. A plurality of parts may be arranged in the label images L11, L12, and L13. In this case, it can be determined whether at least one part is arranged over a plurality of label images L11, L12, and L13.

When it is determined that the parts P10 is arranged over a plurality of label images L11, L12, and L13 (YES in step S13), the processor 2 arranges the frame F10 in the periphery of an area defined by at least two label images L11, L12, and L13 over which the parts P10 is arranged (that is, an area including all areas of the label images L11, L12, and L13) (step S14).

When it is determined in step S12 that the number of label images L11, L12, and L13 to be edited is not two or more (NO in step S12), the processor 2 arranges the frame in the periphery of a single label image (step S15).

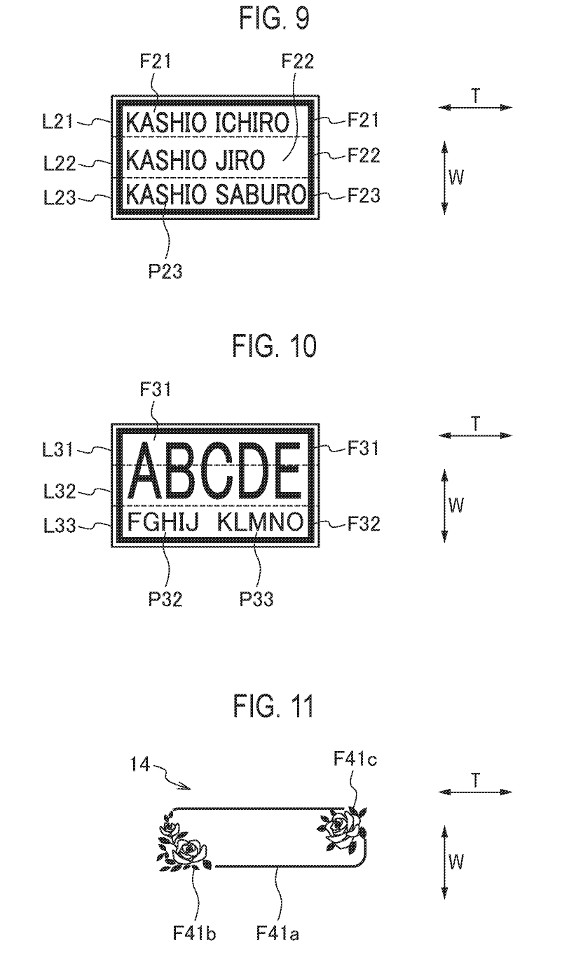

When it is determined that the number of label images to be edited is two or more (YES in step S12) and it is determined that the parts P10 is not arranged over a plurality of label images L11, L12, and L13 (NO in step S13), for example, when only parts P21, P22, and P23 including text of “KASHIO ICHIRO,” “KASHIO JIRO,” and “KASHIO SABURO” which are not arranged over another level image are arranged in label images L21, L22, and L23 as illustrated in FIG. 9, the processor 2 arranges frames F21, F22, and F23 in the peripheries of the label images L21, L22, and L23 (step S15).

As illustrated in FIG. 10, a parts P31 including text of “ABODE” may be arranged over two (a plurality of) label images L31 and L32 which are a part of a plurality of label images L31, L32, and L33 displayed in the label image preparing screen 50 (the image display area 54). In this case, the processor 2 arranges a frame F31 in the periphery of an area defined by the two label images L31 and L32 over which the parts P31 is arranged (step S14), and arranges a frame F33, for example, in the periphery of the label image L33 including a parts P32 including text of “FGHIJ” and a parts P33 including text of “KLMNO” which are not arranged over two or more label images (step S15).

As illustrated in FIG. 11, a frame F41 will be considered in which a preset shape is a shape including a rectangular frame shape portion F41a of which corners are rounded and decoration portions (for example, a picture of a flower) F41b and F41c which are located at two opposite corners in the diagonal direction of four corners of the rectangular frame shape portion F41a. In general, since a length in the second direction T of a label (a label image) differs depending on labels, it is preferable that the shapes and sizes of the decoration portions F41b and F41c be fixed and only a horizontal line extending in the second direction T of the rectangular frame shape portion F41a be extended in the second direction T.

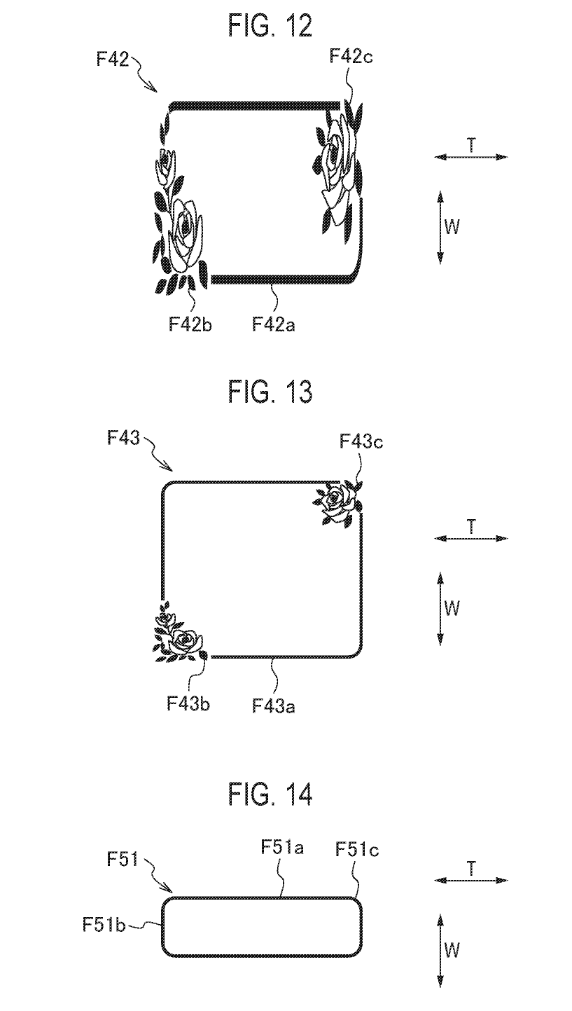

For example, when the frame F41 illustrated in FIG. 11 is simply extended in the first direction W three times like a frame F42 illustrated in FIG. 12 in order to arrange a frame in the periphery of an area defined by three label images as described above, the shapes of the decoration portions F42b and F42c collapse. Although details will be described later with reference to FIGS. 14 to 17, the horizontal line of the rectangular frame shape portion F41a increases three times in thickness. Accordingly, like a frame F43 illustrated in FIG. 13, only the rectangular frame shape portion F43a can be extended three times in only the first direction W in a state in which the shapes and sizes of the decoration portions F43b and F43c are fixed and the thickness of the horizontal line of the rectangular frame shape portion F43a is fixed. Although details will be described later, the shapes of the curved portions at two corners at which the decoration portions F43b and F43c are not located in the rectangular frame shape portion F43a may be fixed. In the frame F10 illustrated in FIG. 8 and the frame F31 illustrated in FIG. 10 having a rectangular frame shape, it is also preferable that the frame be extended in the first direction W with the thickness of the horizontal line fixed.

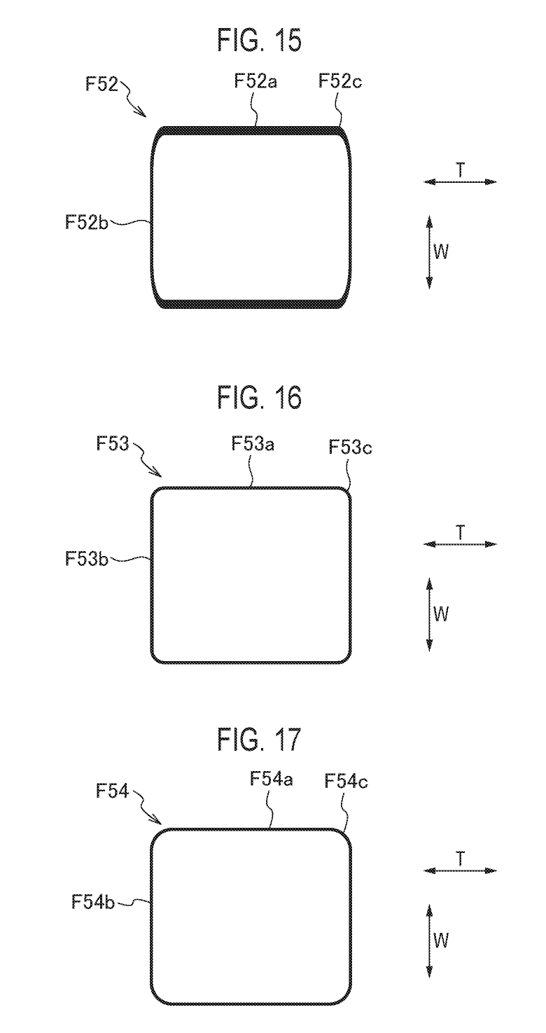

As illustrated in FIG. 14, a frame F51 of which a preset shape is a rectangular frame shape of which corners are rounded will be considered below. The frame F51 includes two horizontal lines F51a extending in the second direction T, two vertical lines F51b extending in the first direction W, and curved portions F51c at four corners having a constant radius of curvature. When the frame F51 illustrated in FIG. 14 is extended three times in only the first direction W like a frame F52 illustrated in FIG. 15, the horizontal line F52a increases three times in thickness and the radius of curvature of the curved portions F52c is not constant (the shape is changed). The thickness of the vertical lines F52b is constant.

Accordingly, like a frame F53 illustrated in FIG. 16, the frame may be extended three times in the first direction W in a state in which the thickness of the horizontal lines F53a and the shape and size of the curved portions F53c are fixed. The thickness of the vertical lines F53b is fixed as described above.

Alternatively, like a frame F54 illustrated in FIG. 17, the size (the radius of curvature) of the curved portions F54c may be increased in a state in which the thickness of the horizontal lines F54a and the vertical lines F54b and the shape of the curved portions F54c are fixed.

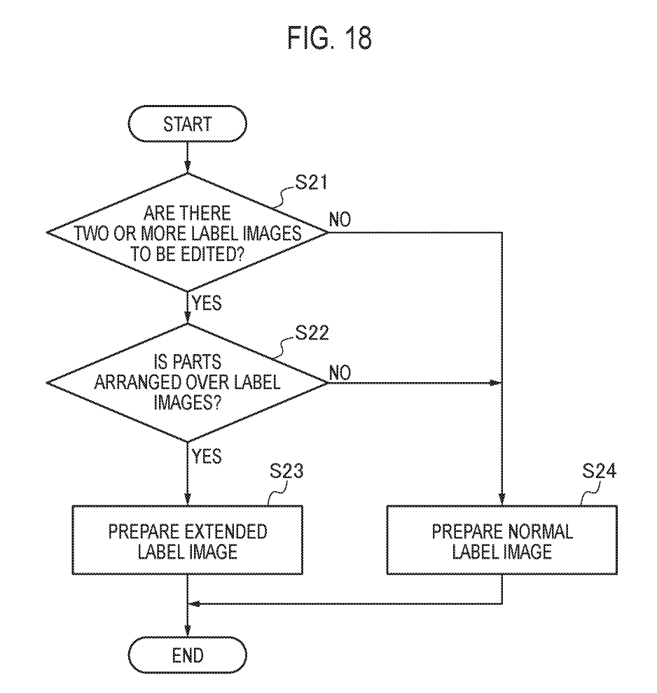

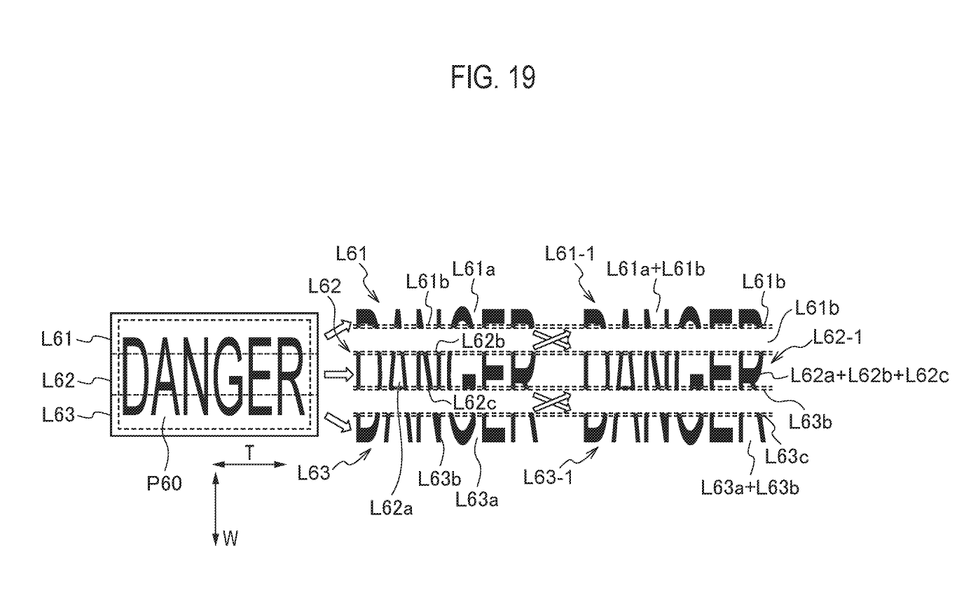

FIG. 18 is a flowchart illustrating extension of label images L61, L62, and L63 illustrated in FIG. 19.

The routine of the flowchart illustrated in FIG. 18 is performed after the processor 2 performs the above-mentioned process of arranging a frame, or after an operation of editing completion of the label images L61, L62, and L63 illustrated in FIG. 19 or an operation of transmitting the label images L61, L62, and L63 to the printing apparatus 100 is received when the process of arranging a frame is not performed.

First, the processor 2 determines whether the number of label images L61, L62, and L63 to be edited is two or more (step S21). This determination process can be performed in the same way as the process of step S12 illustrated in FIG. 7.

When it is determined that the number of label images L61, L62, and L63 to be edited is two or more (YES in step S21), the processor 2 determines whether a parts P60 including text of “danger” which is illustrated in FIG. 19 is arranged over a plurality of label images L61, L62, and L63 (step S22). This determination process can be performed in the same way as the process of step S13 illustrated in FIG. 7.

When it is determined that the parts P60 is arranged over a plurality of label images L61, L62, and L63 (YES in step S22), the processor 2 prepares label images included in at least two label images L61, L62, and L63 over which the parts P60 is arranged as extended label images L61-1, L62-1, and L63-1 which has extended in the first direction W and which include a part of another neighboring label image among the at least two label images L61, L62, and L63 (step S23).

For example, as illustrated in FIG. 19, first, the processor 2 copies image data of end areas L61b, L62b, L62c, and L63b (main areas other than the end areas are L61a, L62a, and L63a) of end portions (for example, 1 mm) of neighboring label images from the label images L61, L62, and L63 and attaches the copied end areas to the neighboring label images. Accordingly, extended label images L61-1 (L61a+L61b+L62b), L62-1 (L62a+L62b+L61b+L63b), and L63-1 (L63a+L63b+L62c) into which the label images L61 (L61a+L61b), L62 (L62a+L62b), and L63 (L63a+L63b) are extended in the first direction W are prepared.

When it is determined that the number of label images L61, L62, and L63 to be edited is not two or more (NO in step S21) or when it is determined that the parts P60 is not arranged over a plurality of label images L61, L62, and L63 (NO in step S22), the processor 2 stores the original label images L61, L62, and L63 of which the extended label images L61-1, L62-1, and L63-1 have not been prepared as edited label images or transmits the edited label images to the printing apparatus 100 (step S24).

In the above-mentioned embodiment, the program is a program for causing a computer to perform printing on a long printing medium M (for example, a program for preparing a label image) on the basis of a plurality of label images L11, L12, and L13 over which a parts P10 to be printed is arranged, and causes the computer to perform: a function of causing a display 5 to display a label image preparing screen 50 as a preparation screen in which a plurality of label images L11, L12, and L13 are arranged such that a length of the first side S1 in the first direction W of one label image of the plurality of label images L11, L12, and L13 corresponds to a length in the width direction of a printing medium M, lengths of the second sides S2 in the second direction T crossing the first direction W of the plurality of label images L11, L12, and L13 coincide with each other, and positions of the first sides S1 in the first direction W are aligned; a function of arranging at least one part P10 in the plurality of label images L11, L12, and L13 in the label image preparing screen 50; and a function of detecting that the parts P10 is arranged over at least two label images L11, L12, and L13 of the plurality of label images L11, L12, and L13.

In this way, by detecting that the parts P10 is arranged over the plurality of label images L11, L12, and L13, it can be determined that a plurality of labels on which the label images L11, L12, and L13 are printed are arranged in the first direction W crossing the second direction T and are adhered to an adhesion object.

In this embodiment, the program causes the computer to further perform: a function of receiving setting of arranging a frame F10 in the periphery of the label images L11, L12, and L13; and a function of arranging the frame F10 in the periphery of an area which is defined by the at least two label images L11, L12, and L13 over which the parts P60 is arranged when it is detected that the parts P10 is arranged over the at least two label images L11, L12, and L13 of the plurality of label images L11, L12, and L13. Accordingly, one frame can be printed on a plurality of labels on which the parts P60 is printed together.

In this embodiment, the frame includes at least one of a picture (the decoration portions F41b and F41c), a figure, a curved portion F51c, and a line (the horizontal lines F51a and the vertical lines F51b), and the function of arranging the frame F10 in the periphery of the area defined by the at least two label images L11, L12, and L13 includes a function of arranging the frame which is arranged in the periphery of a single label image to extend in the first direction W in a state in which at least one of the shape or size of the picture or the figure, the shape of the curved portion F51c, and the thickness of the line (the horizontal lines F51a which are straight lines) extending in the second direction T which is included in the frame F51 are fixed. Accordingly, due to a user who extends the frame in only the first direction W with a size which is arranged in a single label image to be a frame with a size arranged over a plurality of label images, it is possible to prevent the thickness of the horizontal line F52a extending in the second direction T of the frame F52 from increasing to correspond to the enlargement magnification or prevent the shape of the decoration portions F42b and F42c of the frame F42 from collapsing.

In the above-mentioned embodiment, the program causes the computer to further perform a function of preparing the label images included in the at least two label images L61, L62, and L63 over which the parts P60 is arranged as extended label images L61-1, L62-1, and L63-1 which have been extended in the first direction W and which includes a part of another neighboring label image among the at least two label images L61, L62, and L63. Accordingly, by partially printing a parts with a size arranged over a plurality of labels on the labels when a printing medium for preparing a label is conveyed with an inclination in the width direction, it is possible to prevent an end in the width direction of the label image from not being printed.

While embodiments of the present disclosure have been described above, the present disclosure includes the disclosures described in the appended claims and a scope equivalent thereto.

1. A recording medium having recorded a program causing a computer of a label image preparing apparatus to perform:
a function of causing a display to display a preparation screen in which a plurality of label images are arranged such that a length of a first side in a first direction of one label image of the plurality of label images corresponds to a length in a width direction of a printing medium, lengths of second sides in a second direction crossing the first direction of the plurality of label images coincide with each other, and positions of the first sides in the first direction are aligned;
a function of arranging at least one part image as a printing object in the plurality of label images in the preparation screen; and
a function of detecting that the at least one part image is arranged over at least two label images of the plurality of label images.

2. The recording medium having recorded a program according to claim 1, causing the computer to further perform:
a function of receiving setting of arranging a frame in a periphery of the label images; and
a function of arranging the frame in a periphery of an area which is defined by the at least two label images when it is detected that the at least one part image is arranged over the at least two label images.

3. The recording medium having recorded a program according to claim 2, wherein
the frame includes at least one of a picture, a figure, a curved portion, and a line, and
the function of arranging the frame in the periphery of the area defined by the at least two label images includes a function of arranging the frame which is arranged in the periphery of the single label image to extend in the first direction of the label image in a state in which at least one of a shape or size of the picture or the figure, a shape of the curved portion, and a thickness of the line extending in the second direction of the label image are fixed.

4. The recording medium having recorded a program according to claim 1, causing the computer to further perform:
a function of preparing the label image included in the at least two label images as an extended label image which has extended in the first direction and which includes a part image of another neighboring label image among the at least two label images when it is detected that the at least one part image is arranged over the at least two label images.

5. A label image preparing method comprising:
causing a display to display a preparation screen in which a plurality of label images are arranged such that a length of a first side in a first direction of one label image of the plurality of label images corresponds to a length in a width direction of a printing medium, lengths of second sides in a second direction crossing the first direction of the plurality of label images coincide with each other, and positions of the first sides in the first direction are aligned;
arranging at least one part image as a printing object in the plurality of label images in the preparation screen; and
detecting that the at least one part image is arranged over at least two label images of the plurality of label images.

6. A label image preparing apparatus comprising a display and a processor, wherein
the processor is configured to:
cause a display to display a preparation screen in which a plurality of label images are arranged such that a length of a first side in a first direction of one label image of the plurality of label images corresponds to a length in a width direction of a printing medium, lengths of second sides in a second direction crossing the first direction of the plurality of label images coincide with each other, and positions of the first sides in the first direction are aligned;
arrange at least one part image as a printing object in the plurality of label images in the preparation screen; and
detect that the at least one part image is arranged over at least two label images of the plurality of label images.
